(19) United States
(12) Patent Application Publication
(10) Pub. No.: US 2013/0059083 A1
(43) Pub. Date: Mar. 7, 2013

(54) System For Painting Door Areas

(71) Applicant: John D. DeSantis, Monkton, MD (US)

(72) Inventor: John D. DeSantis, Monkton, MD (US)

(21) Appl. No.: 13/226,021

(22) Filed: Sep. 6, 2011

(51) Int. Cl. B05D 3/12; B32B 7/12

(52) U.S. Cl. 427/300; 428/343

(57) ABSTRACT

An improvement of traditional painter's tape for use after painting an object, especially a door. The tape has a conventional adhesive on one side, and a wax or wax-based coating on the opposing side. It is designed so that the adhesive side is placed against a door jamb, and the wax side is to be placed against the painted door when the door is shut. This allows the door to remain operational after painting without the possibility of the door sticking to the door jamb. The present invention can also be placed on a window sill for a freshly painted window, preventing the window from sticking to the window sill.

### FIELD OF THE INVENTION

The invention relates to effectual combination of a painter's tape and a wax-based backing in order to prevent doors from sticking to door jambs after the doors have been painted. Although the invention is aimed primarily at preventing newly-painted doors from sticking to door jambs, it can also be used to prevent newly-painted window sashes from sticking to window sills, and for other newly-painted objects as well.

### BACKGROUND OF THE PRESENT INVENTION

Painting a door or window has always presented a problem. Until a painted door or window sash has completely dried, which can take weeks depending on climate conditions, the door or window sash cannot be closed because sticking will result. The door will stick to the door jamb, and the window sash will stick to the sill. Of course the inability to close a window sash or door creates problems, especially if the door is an exterior door.

To deal with this problem, improvised remedies have arisen. Solutions to this situation currently being offered include leaving the door open for days, silicone spray in the door jam, rubbing wax in the door jam, removing the insulation completely and replacing once paint has dried fully (days or weeks), or any combination of the above. All measures can be less than convenient, a little costly, somewhat labor intensive or messy.

One of the most common methods of dealing with the problem is to use wax or wax paper. The user places a coat of wax or wax paper over the door jamb or window sill, then the door or window sash can be closed without the newly painted object sticking. The wax material is used until the paint has completely and thoroughly dried.

The present invention makes this remedy easily accessible by combining wax material and painter's tape. This is done by placing wax material on the non-adhesive side of painter's tape, which can then be placed on a door jamb, window sill, or other area where fresh paint could cause sticking (Further detail about the features and characteristics of painter's tape is given below in the Summary of the Present Invention.)

U.S. Pat. No. 2,227,453 for “Paint Shield” by Koch, published on Jan. 7, 1941, shows a painting shield for covering surfaces when adjacent areas are being painted. Koch's shield is constructed of “a thin, tough paper” that could be made of wax paper, and mentions its use on a door. However, no mention is made of Koch's invention preventing a newly-painted door from sticking to a door jamb, and no mention is made of placing wax material on the non-adhesive side of painter's tape.
U.S. Pat. No. 6,033,736 for “Aqueous Wax Emulsion as Paint Primer and Paint Repair Adhesive” by Perlman et al., published on Mar. 7, 2000, shows a method called aqueous wax emulsion that forms an aqueous wax emulsion coating that is waterproof and prevents “moisture-related bubbling and peeling of the new and older paint coatings.” Although Perlman et al. use wax to effect painting solutions, no specific mention is made of utilizing wax to prevent a newly-painted door from sticking to a jamb.
U.S. Pat. No. 5,387,434 for “Anti-Graffiti Coating Material and Method of Using Same” by Black, published on Feb. 7, 1995, shows a method of treating a surface with a wax emulsion in order to facilitate removal of graffiti from the surface. Unlike the present invention, Black makes no mention of preventing a newly-painted door from sticking to a door jamb.
U.S. Pat. No. 4,349,586 for “Anti-Adhesive Composition Based on Wax in Organic Solvent Medium” by Sejournant, published on Sep. 14, 1982, shows an anti-adhesive composition, containing one or more waxes, that “makes it possible to form a protective coating for walls against bill-posting, penetration and attachment of graffiti and/or paint and against adherence of dust and miscellaneous polluting agents in and on such surfaces.” Unlike the present invention, no specific mention was made of preventing newly-painted doors from sticking to door jambs.

### SUMMARY OF THE PRESENT INVENTION

The present invention, an adhesive tape composed of a wax or wax-based polymer coated paper, similar to conventional wax paper, only more durable, and with the approximate consistency of conventional painter's tape. As a tape, on the side opposing the wax-based coating, there exists an adhesive adequate to secure the present invention in its optimal user-defined placement.

The present invention is envisioned in several embodiments. In one embodiment, wax is fused directly to the back of a conventional form of painter's tape. Contrastingly, in another embodiment, a sheet of wax is adhered to the back of the tape. In the latter embodiment, the strength and flexibility of the wax sheet is of higher durability than ordinary household wax paper, which would be too delicate to accomplish the aims of the present invention when subjected to friction. In an additional third embodiment, the composition of the tape revolves around a plastic or acrylic foundation strip, with the wax paper affixed to one side with adhesive, and a second layer of adhesive is placed on the reverse side of the core strip, providing an avenue of sticking the tape to a target.

The pattern of the present invention's adhesive is consistent, similar to conventional painter's tape, providing for easy and even removal. A balance is struck between adhesion strength and gentle release, so as not to damage the dry surface to which the tape adheres. The present invention may preferably vary in the thickness of the wax coating, as well as the adhesive durability level of the adhesive found on the opposite side of the tape.

The present invention is envisioned in various widths and thicknesses for different types of jobs. Door jamb widths will vary, and freshly painted window sashes require a shorter, wider style of tape for placement along the bottom of a window sill. Differing types may be fashioned for specific purposes, such as use on a specific type of door jamb, such as on a segmented, flat-panel garage or hangar door. A specific size and rating would preferably be established for use on automobile and marine doors as well.

The present invention is envisioned as placed on a window sash in order that a freshly painted window sash can be closed without sticking resulting. The present invention is envisioned in spools and rolls, as well as in squares or circle shapes for indoor and outdoor furniture, sliding doors, car doors, etc.

While there are many embodiments of the present invention, the preferred embodiment implements a durable wax-based paper backing to be fused directly to a tape similar in thickness and consistency to conventional painter's tape. This is preferable to other designs because tests show it to be the most flexible, in comparison to simply coating the top side of conventional painter's tape with a wax-based compound, as this would likely be inflexible and perhaps crack. The wax paper is preferably of a thicker and more durable construction than traditional household wax paper.

### A BRIEF DESCRIPTION OF THE DRAWINGS

FIG. 1 depicts a strip of the preferred embodiment of the present invention as viewed from the bottom.

FIG. 2 depicts a strip of the preferred embodiment of the present invention as viewed from the top.

FIG. 3 shows the present invention as featured in a roll.

FIG. 4 exhibits the multiple layers of an alternate embodiment of the present invention.

### DETAILED DESCRIPTION OF THE PRESENT INVENTION

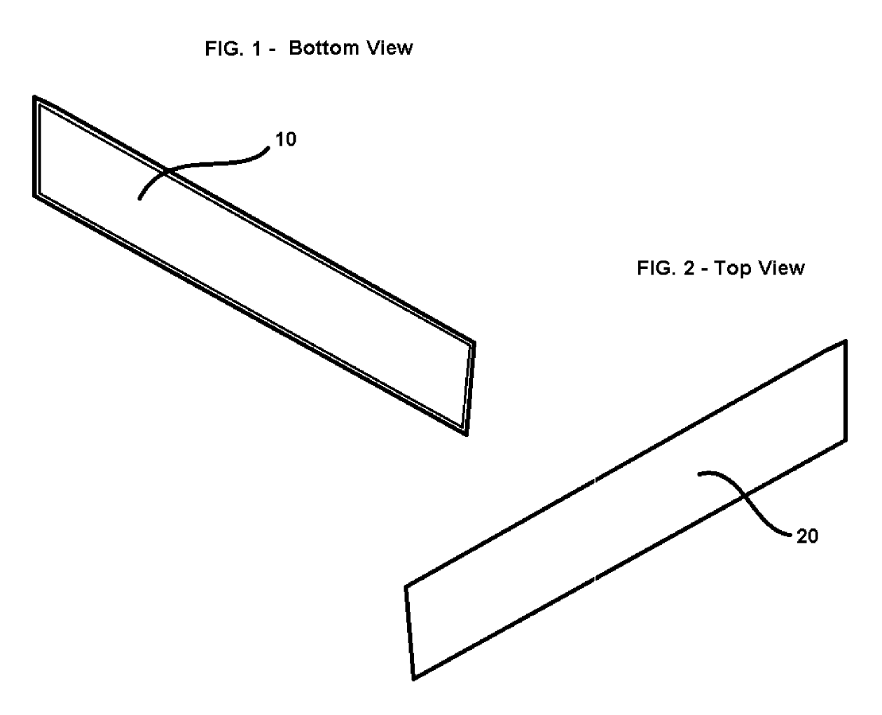

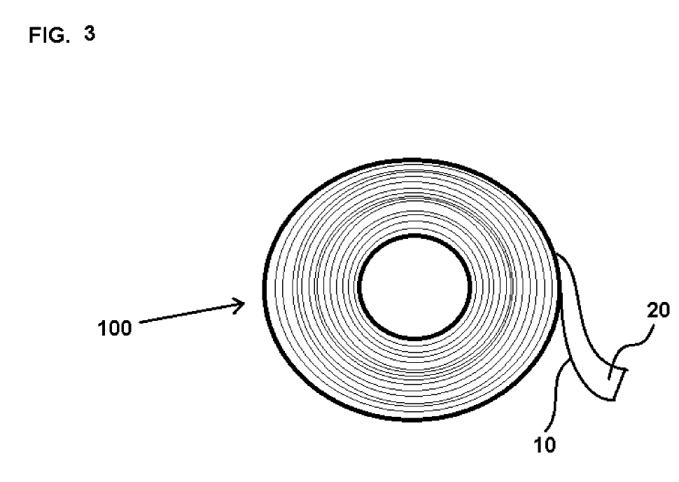

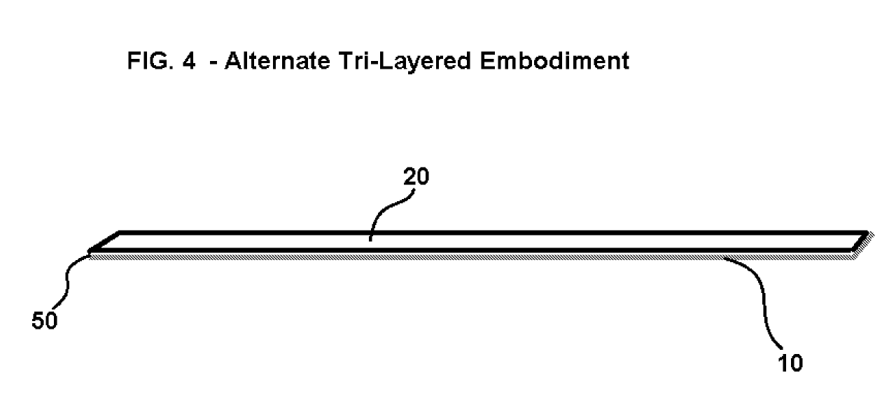

The present invention, a variant of conventional tape, wherein the side opposite of the adhesive backing (10) is affixed to a wax-based backing (20) that maintains properties similar to that of conventional wax paper, such as being smooth, dry, and inert. As seen in FIG. 1, the preferred embodiment of the present invention is equipped with an adhesive (10) that is both effective in retaining the present invention in the desired location and position, as well remaining relatively easy to remove. It is envisioned that the adhesive integrity of the present invention could vary in accordance with the day-rating scale conventionally used to grade painter's tapes. It is the intent of the present invention to prevent binding between two items, mechanisms, or areas, such as window or door thresholds that are often subject to being painted, thus causing them to bind and get effectively stuck as the paint dries. In extreme cases, a fresh coat of paint on a door threshold or window sash, followed by the closing of said door or window, may cause the door or window to be bound closed, as though glued in place permanently. The present invention intends to be an easy method of avoiding this unfortunate scenario.

It is envisioned that the wax-based backing (20) of the tape (100) is to be ‘fused’ to the adhesive portion of the tape, making it unlikely that the backing would separate from the central acrylic or plastic based ‘foundation tape’ (50) found in the center of an embodiment of the present invention, wedged between the wax-based backing (20) and the adhesive layer (10) portions of a 3-part tape structure. However, in the preferred embodiment, it is envisioned that the wax-based backing (20) could be designed to be affixed to a sturdy form of paper, accompanied with a minimal application of adhesive (10), keeping the tape (100) in its optimal applied position for the duration of the drying time. In this embodiment, the present invention would feature no center ‘foundation’ tape (50) as displayed in FIG. 1. It would most closely resemble conventional painter's tape, but rather than maintaining a smooth, papery, often blue top side, the tape would exhibit a layer of wax-based backing (20), all implemented into a single sheet or piece of tape (100).

All embodiments of the present invention feature at least two layers: a layer of wax-based backing (20) similar in consistency and construction to conventional wax paper, and an adhesive (10), providing the present invention with a means of effectively remaining in place where applied by a user. Both the wax-based backing (20) and the accompanying adhesive (10) can be fashioned of differing widths and thicknesses, as well as durability ratings to indicate how much stress the particular variant of the present invention can handle under normal use. For example, if the user wishes to apply the present invention to a window or door that is used frequently, such as several times per day, then he or she would likely wish to use employ one of the more durable wax-coated tape variants, likely a tape with a stronger adhesive rating, in order to ensure that the application of the present invention would remain intact for the duration of the time required for the paint or other polymer to dry.

The adhesive (10) of the present invention is preferably evenly distributed across the reverse side of the tape. The adhesive (10) is preferably available in an assortment of differing durability and elasticity ratings. The adhesive (10) is preferably clear, in order to reduce the chance of leaving a stain on the target surface, such as a window sill, when the present invention is removed from the surface. However, it can be envisioned that, in alternate embodiments of the present invention, the adhesive, or indeed, the tape as a whole, could be dyed to match any color of paint.

It should be understood that the wax-based backing (20) of the present invention need not necessarily be authentically wax-based, but may implement a synthetic wax substitute in order to achieve the same result. Other technologies or compounds achieving the same means, such as silicone, may also be employed in alternate embodiments of the present invention in order to prevent painted windows and doors from sticking closed while drying. Similarly, it is to be understood that the wax-based backing (20) of the present invention need not solely be used on standard paints, but that it would find utility when used in conjunction all paints and finishes including latex based or water based paints, oil-based or solvent-based products, including urethane, poly-urethane, polymers, plastics, powder coatings etc. Indeed, the method of the present invention involves the application of the present invention to a door jamb either before painting or shortly after painting, in order to ensure that the fresh paint does not stick together when the door binds against the tape upon moving within the threshold of the door.

The present invention is also envisioned as used for newly constructed homes, employing an extra delicate release adhesive so all the doors in the home don't have to remain open for weeks after completion. It can be envisioned that a form of the present invention could be designed for this application, and be titled the “new construction” product. The potential applications of the present invention appear limitless, especially with regard to any drying fluid application. Likewise, it is envisioned that the consumer will continue to find new ways to employ the method of the present invention, as well as discover new applications for the present invention.

Similarly, it can be envisioned that an alternate embodiment of the present invention could feature weather or climate-proofing qualities built into the adhesive. This would be prudent for applications of the present invention where the tape (100) may become wet or exposed to the elements, such as the front door to a home, or a hatch seal on a boat. The wax-based backing (20) would already preferably be highly waterproofed due to the nature of its composition.

It is to be understood that the present invention is an enhanced tape product composed of an adhesive and an inert material affixed to said material. The inert material is preferably uniformly applied to the adhesive. The inert material is pliable. Similarly, the adhesive is preferably graded by strength. Preferably, the inert material of the present invention is preferably made of a thick wax-based paper. The present invention is configured to leave preferably no residue when applied to an object surface, and later removed. Similarly, it is envisioned that in alternate embodiments of the present invention, a central core strip layer exists between the adhesive and inert materials, and is in direct communication with both the adhesive and inert material, such as wax-like paper.

Subsequently, it is also to be understood that the present invention relates to a method for using tape comprising affixing an adhesive surface of the tape to a door jamb that was freshly painted. The door may then be pressed against the wax-based surface of the tape, found opposite of the adhesive. The door may then be opened away from the wax-based surface of the tape without the paint being removed from the door. The tape is established as being an adhesive and an inert material affixed to said adhesive. The inert material is uniformly affixed to the adhesive.

I claim:

1. An enhanced tape product, comprising:
an adhesive; and
an inert material affixed to said adhesive.

2. The enhanced tape product of claim 1, wherein said inert material is uniformly affixed to said adhesive.

3. The enhanced tape product of claim 1, wherein said inert material is pliable.

4. The enhanced tape product of claim 3, wherein said adhesive is graded by strength.

5. The enhanced tape product of claim 2, wherein said adhesive is configured to leave no residue when applied to an object surface, and later removed.

6. The enhanced tape product of claim 1, wherein said inert material is wax-based paper.

7. The enhanced tape product of claim 1, wherein said inert material is affixed to said adhesive via a central core strip.

8. The enhanced tape product of claim 7, wherein said central core strip is acrylic.

9. The enhanced tape product of claim 1, wherein said adhesive and said inert material are arranged in layers.

10. The enhanced tape product of claim 1,
wherein said inert material is uniformly affixed to said adhesive;
wherein said inert material is pliable;
wherein said adhesive is graded by strength of adherence to objects.
wherein said adhesive is configured to leave no residue when applied to an object surface, and later removed;
wherein said inert material is wax-based paper;
wherein said inert material is affixed to said adhesive via a central core strip
wherein said central core strip is acrylic; and
wherein said adhesive and said inert material are arranged in layers.

11. A method for using tape, comprising:
affixing an adhesive surface of the tape to a door jamb;
painting a door with paint;
pressing the door against a wax-based surface of the tape as the door is closed against the door jamb; and,
opening the door away from the wax-based surface of the tape without the paint being removed from the door.

12. the method of claim 11, wherein the tape is an adhesive; and
an inert material affixed to the adhesive.

13. The method of claim 11, wherein inert material is uniformly affixed to the adhesive.

14. A method for using tape, comprising:
affixing an adhesive surface of the tape to a door jamb;
painting a door with paint;
pressing the door against a wax-based surface of the tape as the door is closed against the door jamb; and,
opening the door away from the wax-based surface of the tape without the door sticking to door jamb.
